(19) United States
(12) Patent Application Publication
(10) Pub. No.: US 2016/0113437 A1
(43) Pub. Date: Apr. 28, 2016

(54) Water Container for a Beverage Machine as well as Beverage Machine

(71) Applicant: JURA Elektroapparate AG, Niederbuchsiten (CH)

(72) Inventors: Philipp Büttiker, Oberbuchsiten (CH); Philipp Baur, Utzenstorf (CH)

(21) Appl. No.: 14/918,902

(22) Filed: Oct. 21, 2015

(30) Foreign Application Priority Data
Oct. 28, 2014 (EP) 14405076.2

(51) Int. Cl. A47J 31/46; B65D 25/28; B65D 43/16

(52) U.S. Cl. CPC A47J 31/462; B65D 43/16; B65D 25/28; B65D 2525/283

(57) ABSTRACT

A water container for a beverage machine, in particular a fully automatic coffee machine, as well as a beverage machine comprising such a water container are specified. With the goal of also ensuring the fillability of the water container when attached to the beverage machine and of improving the manageability of the water container, which may be removable from the beverage machine, the water container may have a filling opening, which can be covered by means of a lid, wherein, when the water container is attached to the beverage machine, a filling area is defined above the filling opening, and wherein the lid can be guided by means of a guide device, which provides for a pivoting of the lid out of the filling area into at least one predetermined or predeterminable open position, so that the filing area can be accessed freely at least from the top.

The instant invention relates to a water container for a beverage machine. The instant invention further relates to a beverage machine, preferably a fully automatic coffee machine, which is provided with a water container.

Beverage makers, such as fully automatic coffee machines and the like, for example, are often provided with a removable water container, by means of which the supply of fresh water is ensured for a beverage making process.

To avoid the penetration of dirt particles (dust, etc.) into the fresh water on the one hand and to ensure an optically balanced appearance of such a beverage machine on the other hand, the water tanks or water containers, respectively, of common beverage machines are often provided with a lid, which, when the water container is assembled on the beverage machine, for example in the case of a lateral attachment or the like, offers a more or less smooth-surfaced closure, which reduces the dust permeation, in the direction from above the water container.

To make it possible to refill fresh water into the water container, it is necessary on the one hand, to open or to remove the lid, respectively, and to thus expose a filler opening of the water container; on the other hand, it is necessary or at least possible—depending on the design of the device or also according to customer request, to remove the water tank or water container, respectively, from the beverage machine, for example so as to carry it to a water tap or the like.

Common water containers for beverage machines hereby often have relatively complicated curved pivot mechanisms, as known from publication EP 2 721 975 A1, for example. It is disadvantageous hereby that, in the unfolded state (opened state) above the filling opening of the water container, that is, above an upper edge of the water container in the open state, the lid remains in a filling area of the water container. As a result, an operator, who refills the water container, has to remove the water container from the beverage machine and that the operator can subsequently fill the water container only in a relatively cumbersome manner and quasi past the lid, which remains in the filling area, at an angle from above.

On the other hand, a pure folding solution of the lid, which is arranged on the end side of the water container, is provided in publication DE 10 2004 004 837 B4, for example. Even though the lid can hereby be pivoted relatively far out of the filling area above the filling opening in the state, in which it is attached to the beverage machine, the disadvantage of this is that the water container of this common solution, which can be removed from the beverage machine, is difficult to handle in the removed state, because a handling option, such as a handle or the like, for example, for carrying it is not present. Similar end-side folding mechanisms in the case of lids for water containers without a pivoting option and without improved handling options are known from EP 0 404 688 A1 as well as from WO 2011/089210 A1, for example.

The problem thus arises in each case that the water tank lid cannot be opened completely when the water tank is inserted into the device. The tank needs to then in each case be removed from the device for refilling. In the case of lids, which can substantially be unfolded completely, it is difficult on the other hand in the case of common solutions to remove the water tank out of the device or detach it from the device, respectively, for cleaning or refilling purposes, because the handling is made more difficult by the lack of handling options.

It is thus the object of the instant invention to specify a water container for a beverage machine, in the case of which the handling options as well as the refilling options are improved simultaneously.

With reference to the water container, the object is solved by means of a water container for a beverage machine comprising the features of independent claim 1. With reference to a beverage machine, which is provided with a water container, the object is solved by means of a beverage machine comprising the features of claim 9.

With reference to the water container, the object is solved in particular by means of a water container for a beverage machine, which water container has a filling opening, which can be covered by means of a lid and which is embodied so as to be capable of being attached to the beverage machine and to be removed from the beverage machine, so that, when the water container is attached to the beverage machine, a filling area is defined above the filling opening. The lid is arranged on the water container so as to be movable and is guided by means of a guide device in such a manner that the lid can be pivoted out of the filling area into at least one predetermined or predeterminable open position, so that the filing area can be accessed freely at least from the top. The lid is furthermore supported in a rotatable manner by means of the guide device in such a manner that a cover surface of the lid can be brought into an at least partial contact (i.e. at least one portion of a cover surface of the lid can be brought into contact) with an outer surface of the water container in the open position or in at least one of the open positions, respectively, so that the lid assumes an unfolded position.

Through this, it is possible in an advantageous manner to optionally fill the water container when attached to the device, for example by means of a separate water vessel or the like, because the filling area, that is, the area above the filling opening of the water container, does hinder a filling of water due to its position when the lid is open, also when attached to the device. At the same time, the manageability of the water container is not limited when removed from the device, so that a removal from the device is possible in a simple manner for a filing process, but also for a cleaning process of the water container or the like. Due to the fact that the lid of the water container rests against the outer surface of the water container in a corresponding open position in the unfolded position, a smallest possible projection of the lid to the side results, that is, a smallest possible hindrance of a possible refilling process in lateral direction. In the unfolded position of the lid, at least one side of the lid, for example one of the longitudinal sides of the lid, is preferably located below a flange of the filling opening. In other words: In response to fastening the guide device to the narrow sides of the lid, the lid can be brought into at least partial contact (i.e. at least one portion of the lid can be brought into contact) with the outer surface of the water container by means of the pivoting movement on the one hand and the rotation on the other hand, such that at least one of the longitudinal sides and preferably both longitudinal sides are located below the upper flange of the water container in the attached position thereof. This results in an even better lateral accessibility of the filling opening and thus in a filling process, which is facilitated even more, when refilling the water container in the attached state.

In an embodiment of the water container, provision is made, for example, for the lid to have a substantially rectangular base area and to be supported so as to be pivotable about a first axis and so as to be rotatable about a second axis by means of the guide device on two sides of the lid, which are located opposite one another.

Due to the rectangular base area, a simple production of the lid is possible; due to the support of the lid by means of the guide devices on sides, which are located opposite one another, typically on the narrow sides of the lid, about the fastening axis of the guide device provided on both sides of the lid, a rotation of the lid about this fastening axis in addition to the pivoting is possible simultaneously, so that the lid can be moved out of the filling area even better and the filling can thus be made possible even better when installed on the device.

According to a further aspect of the invention, the guide device for supporting and for pivotably guiding the lid has a first guide arm and a second guide arm located opposite thereto. Each of the guide arms hereby has a joint on the container side for supporting the corresponding guide arm on the container in a rotatably movable manner and, in each case, a joint on the lid side for supporting the lid in a rotatably movable manner.

Due to the rotatable support of each of the guide arms about the respective joint on the container side, provision is made for a simple pivoting option of the lid into a position, in which the lid is located above the filling opening. From this position, a simple, yet effective option is created for pivoting the lid out of the filling area and out of an adjoining lateral area as far as possible for a refilling process by further rotating about the respective joints on the container side and by simultaneously rotating the lid about the joints on the lid side. In this manner, it is simultaneously made possible to use the lid as a carry handle for the water container in the at least partially open state. Due to the usability of the lid as handle, namely as carry handle for the water container, it is possible to refill the water container easily even in the removed state, for example under a water tap or the like.

According to a further aspect of the invention, provision is made for the lid to have a contact part, which, in a closed position of the lid, faces the inner side of the container of the water container, as well as a cover part, which, in the closed position of lid, is exposed to the outside. A particular design of the contact part or the particularly matched design of contact part and cover part to one another, respectively, at least on the edge and flange areas thereof (e.g. the provision of specific beveling) allows for an unobstructed pivoting of the lid in response to the opening process. Due to the presence of multiple parts, an easier adaptability to different container shapes is possible at the same time.

According to a further aspect of the invention, the cover surface is a surface of the contact part, which is located on the outside. This cover surface, which thus faces the inner side of the container of the water container in the closed position of the lid, rests against the outer side of the container in the open position of the lid in the unfolded state. It is possible through this to keep the pivot radius of the lid, which is supported on the guide arms, relatively small, which provides for a simple design of the pivot mechanism with relatively small material expenditure. It is important to note hereby that inner side of the container refers to all sides in the interior of the container or the inner volume of the container, respectively, thus for example also the bottom area of the water container.

According to a further aspect of the invention, provision is made for the lid to be supported eccentrically on the water container. It is possible through this that, when the lid is used as carry handle for the water container, the center of gravity of the filled container runs eccentrically with reference to an imaginary horizontal plane, which runs through the supported water container, whereby the manageability is improved once again. The reference hereby is the position of the joints for the guide arms on the water container, that is, the position of the joint of the first guide arm on the container side as well as the position of the joint of the second guide arm on the container side.

An exemplary embodiment of the solution according to the invention will be explained in more detail below by means of a drawing.

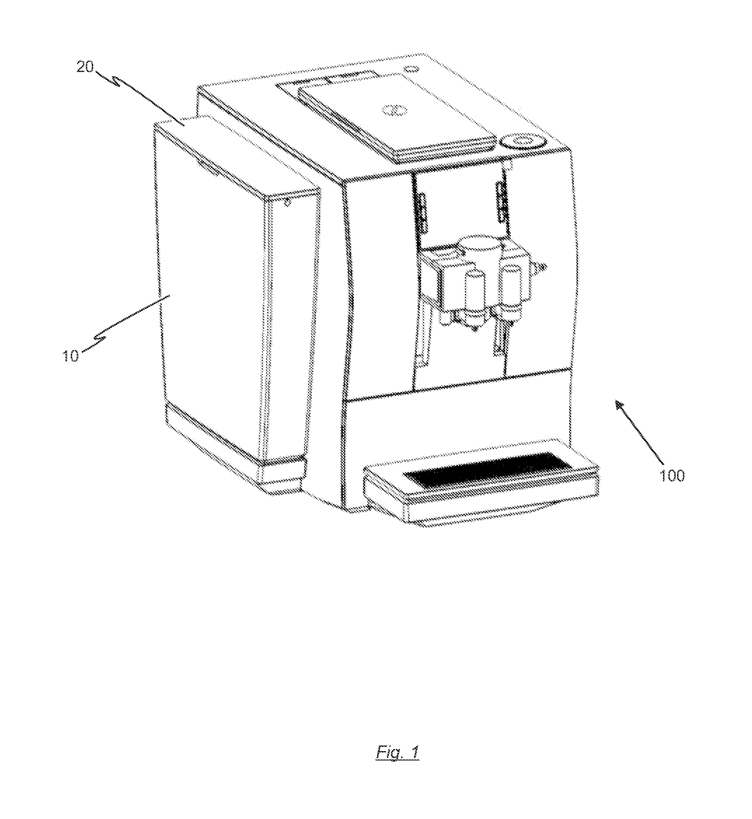

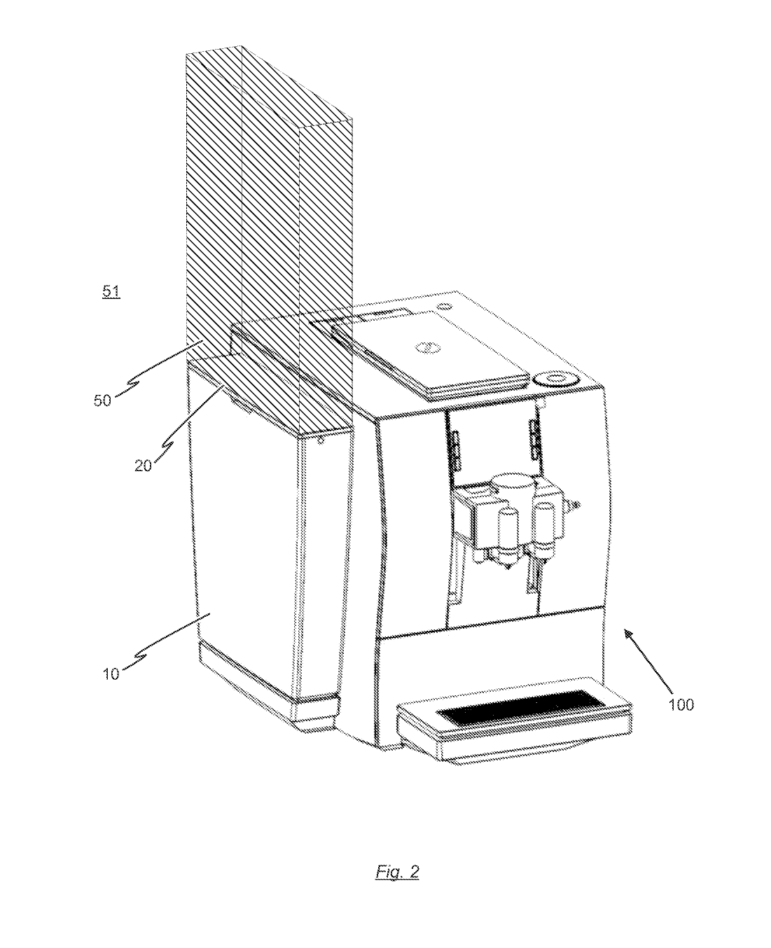

FIG. 1: shows a perspective view of a beverage machine, which is provided with a water container according to an embodiment of the invention;

FIG. 2: shows the perspective view from FIG. 1, supplemented by a graphic illustration of the filling area above the lid of the water container;

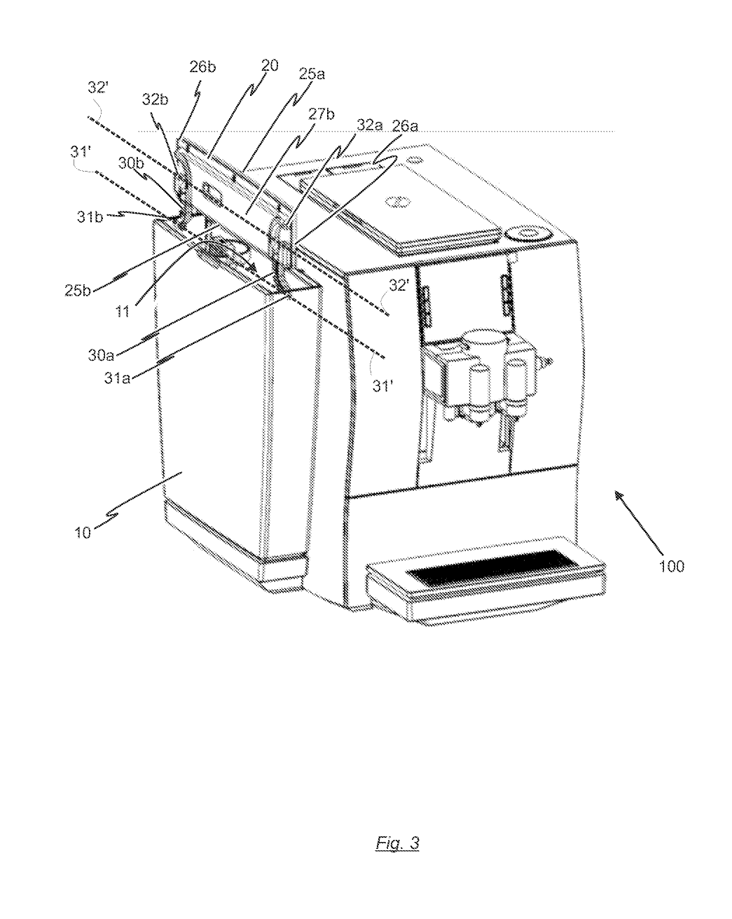

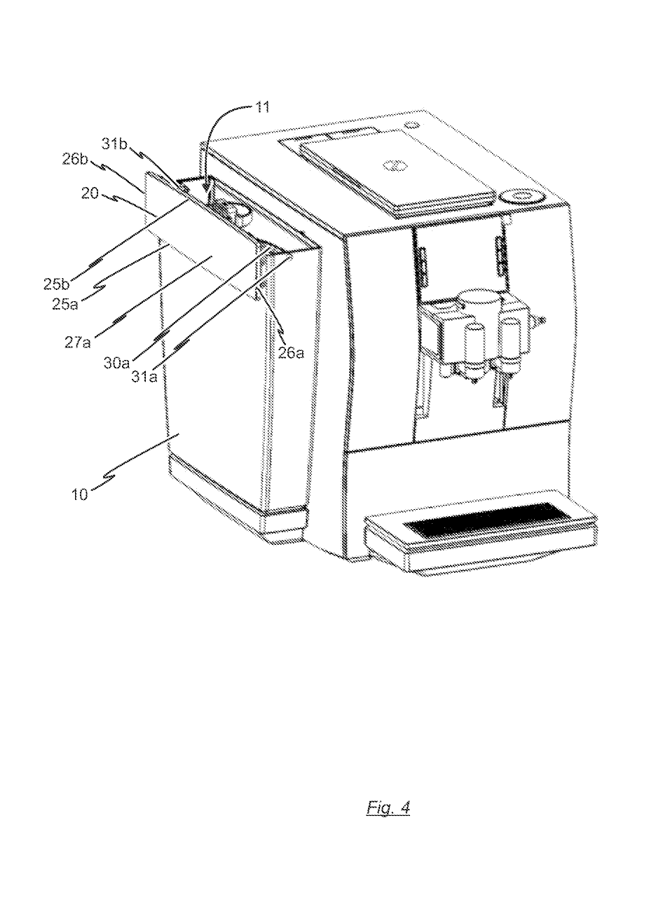

FIG. 3: shows a schematic view of the beverage machine according to FIGS. 1 and 2 comprising a water container according to the invention according to the embodiment with partially open lid;

FIG. 4: shows a perspective illustration of the beverage machine comprising the water container according to the embodiment from FIGS. 1 to 3 with the lid in the unfolded state;

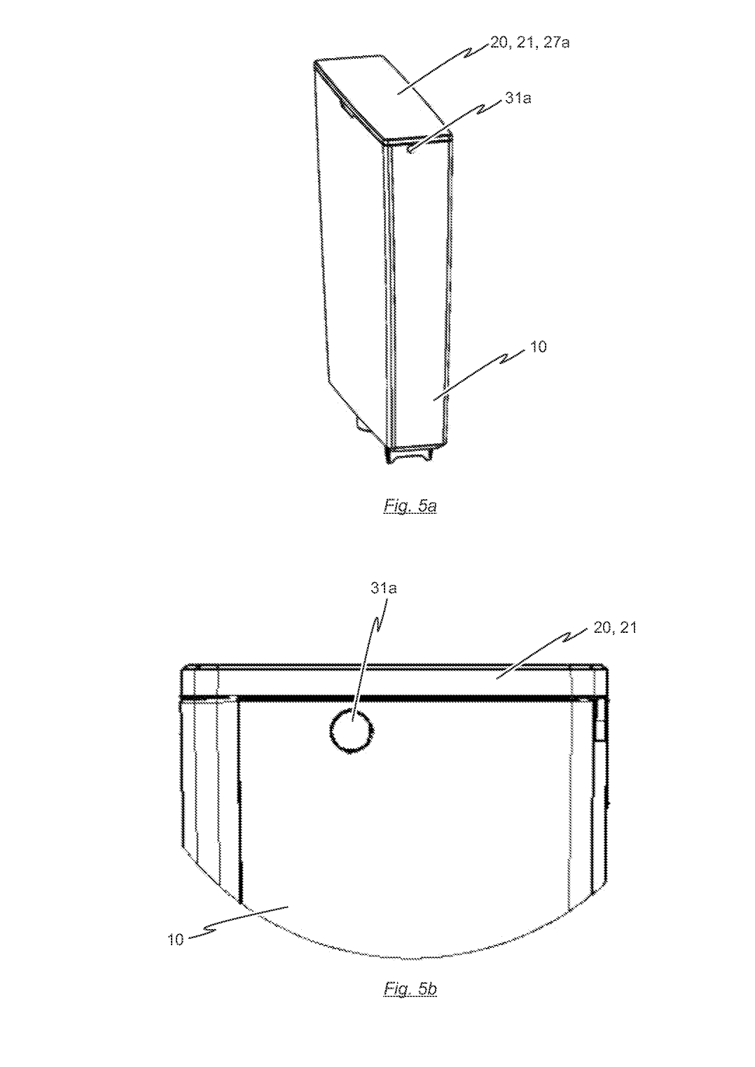

FIG. 5a, 5b: show a perspective view or a detail enlargement, respectively, in side view of a water container, which is illustrated separately, according to the embodiment with the lid in the closed state;

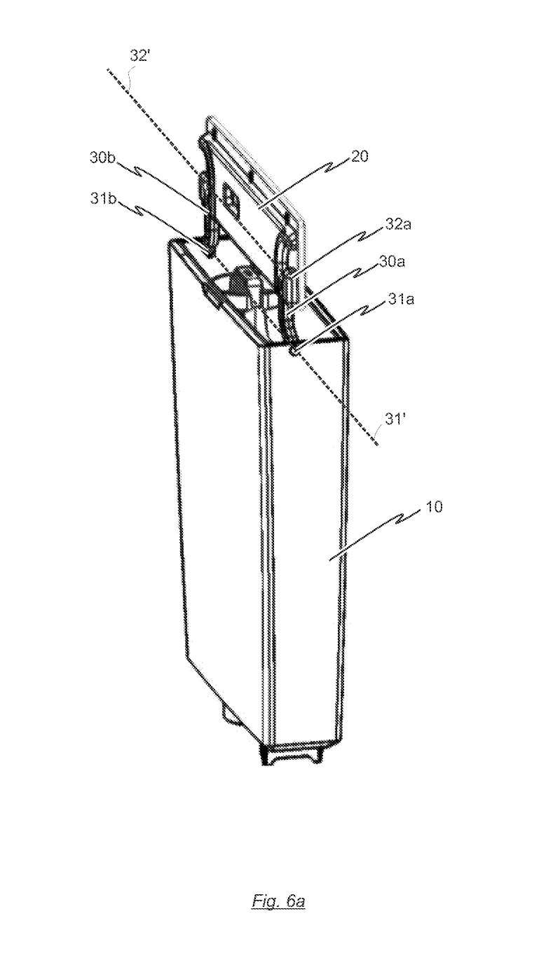

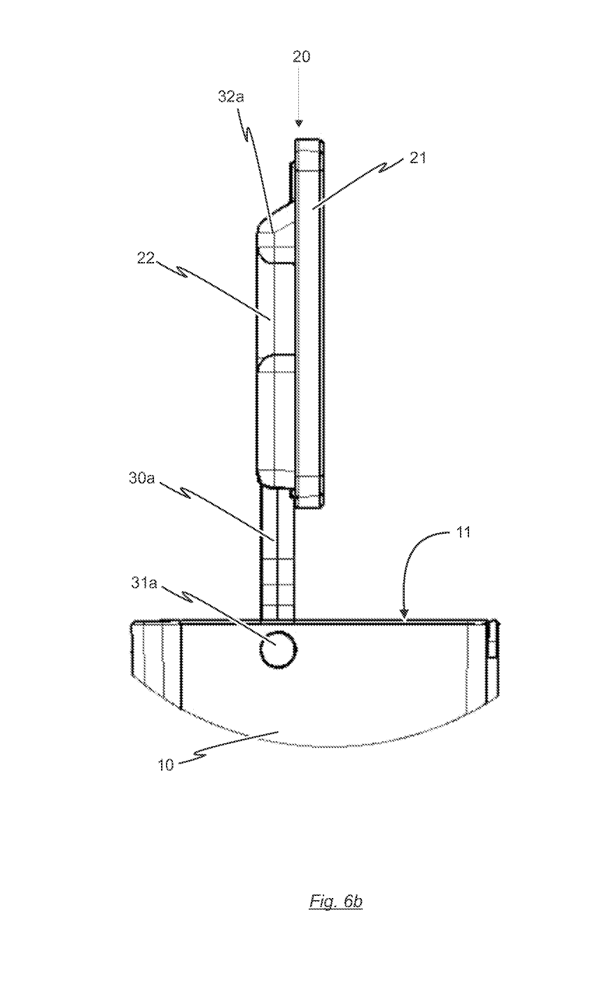

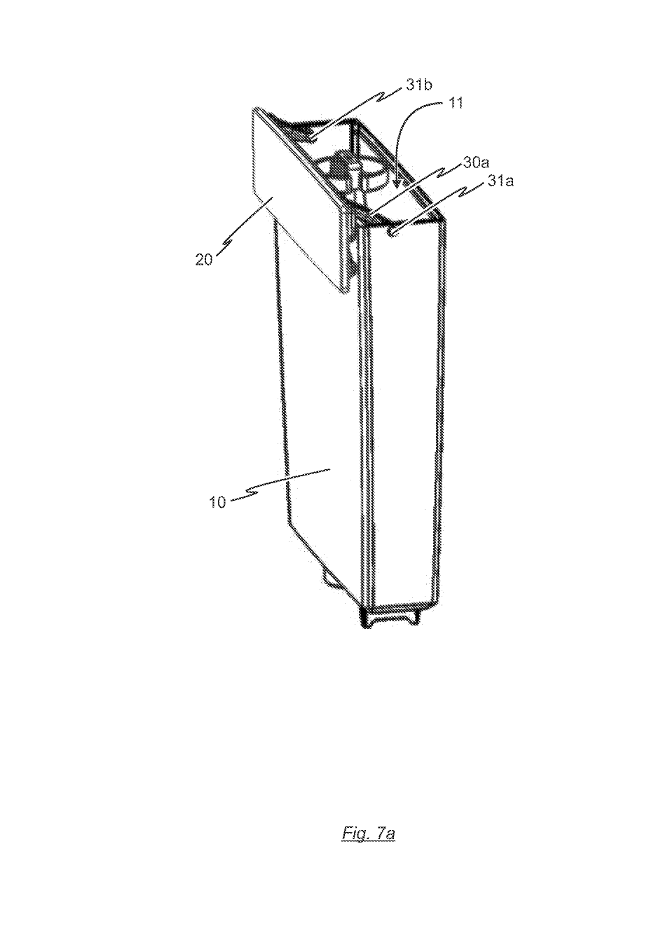

FIG. 6a, 6b: show views analogous to FIGS. 5a and 5b, with the lid in a partially open position; and

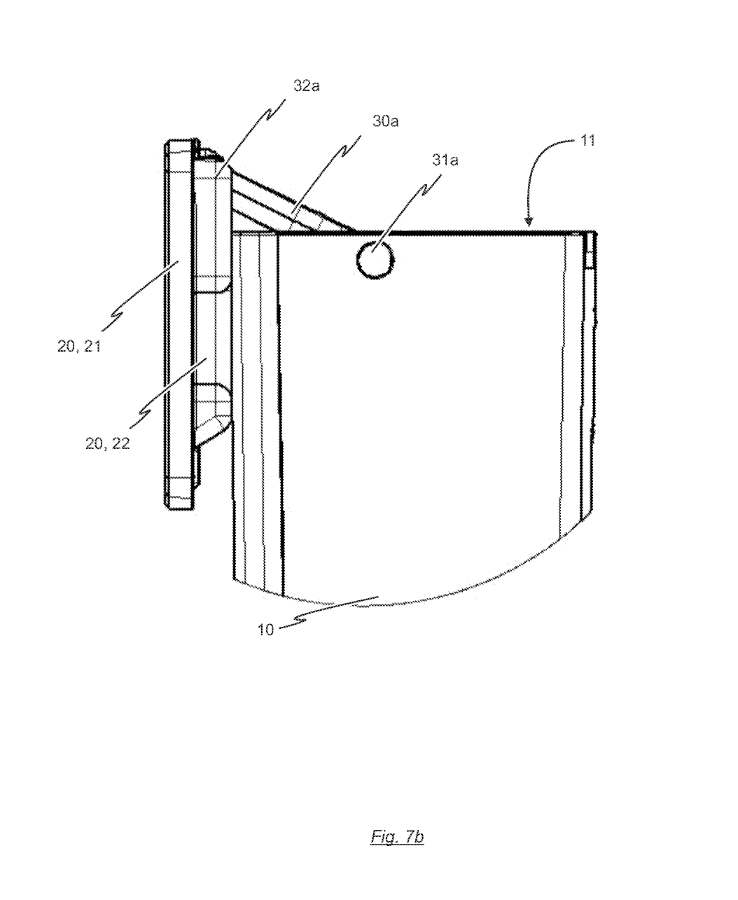

FIG. 7a, 7b: show views analogous to FIGS. 5a and 5b or 6a and 6b, respectively, with the lid in its unfolded position.

In a perspective overview illustration, FIG. 1 shows a beverage machine 100, to which a water container 10 according to an embodiment of the invention is attached on the side. The water container 10 can be filled with fresh water and, for this purpose, has a water supply device (not illustrated in the drawings) in its lower area for supplying water to the beverage machine 100, which water supply device prevents the water from uncontrollably spilling out of the water container 10 by means of a non-return valve or the like, for example, in the event that the water container 10 is removed from the beverage machine 100.

The water container 10 is provided with a lid 20, which ensures a homogenous optical covering of the water container 10 on the one hand and which prevents the penetration of dirt particles, such a dust or the like, for example, in particular in the case of longer service life of the beverage machine 100 on the other hand. In the perspective illustration according to FIG. 1, the lid 20 is in its closed position.

An illustration analogous to the perspective illustration from FIG. 1 of the beverage machine 100 with attached water container 10 and closed lid 20 is shown in FIG. 2 only for explanatory purposes. However, a filling area 50 above the lid, which, when the lid is open when the water container 10 is attached to the beverage machine 100, is to preferably be kept free, is hereby suggested schematically, so as to provide for an unhindered access to the filling opening of the water container 10. In addition, it is also preferred to keep the lateral area 51, which faces away from the beverage machine 100, free above the water container 10 in the installed state thereof, so as to ensure that a vessel can draw near in an unhindered manner from this lateral area 51, if possible, for refilling the water container 10.

As now follows from the perspective illustration in FIG. 3, provision is made in the case of the water container 10 according to the illustrated exemplary embodiment for a guide mechanism for guiding the lid 20 from its closed position (see FIGS. 1 and 2) into one or a plurality, respectively, of opened positions (open positions). To expose the filling opening 11 of the water container 10, the lid 20 can be opened and pivoted out of the filling area 50 by means of the guide device. By using the individual perspective depiction of the water container 10 according to the embodiment from FIG. 6a as well as of the corresponding side view in detail enlargement from FIG. 6b, the following can be seen: provision is made on each of the narrow sides 26a, 26b of the lid 20 for a guide arm 30a, 30b, in the illustration according to FIGS. 3 or 6a and 6b, respectively, a first guide arm 30a located in the front as well as a second guide arm 30b located in the back. The first guide arm 30a is rotatably supported on the water container 10 by means of a joint 31a of the first guide arm on the container side. Analogously, the second guide arm 30b is also supported in a rotatably movable manner on the water container 10 on the opposite side by means of a joint 31b of the second guide arm on the container side. Thanks to the joints 31a, 31b on the container side, the lid 10 can be pivoted about a first axis 31′ relative to the water container 10 by means of the guide arms 30a, 30b.

On its narrow side 26a, which is located in the front in the illustrations, the lid 20 is rotatably supported on the first guide arm in a similar manner by means of a joint 32a of the first guide arm on the lid side; in an analogous manner, in turn, the lid 20 is rotatably supported on the narrow side 26b by means of a joint 32b of the second guide arm 30b on the lid side, so that an axis of rotation of the lid is defined by the respective joints 32a, 32b on the lid side. Thanks to the joints 32a, 32b on the lid side, the lid 10 can be rotated about a second axis 32′ relative to the guide arms 30a, 30b. The second axis 32′ is arranged at a distance to the first axis 31′. Accordingly, the second axis 32′ is arranged so as to be capable of being pivoted about the first axis 31.

As follows in particular from the illustration in FIG. 6b, the lid has a contact part 22 as well as a cover part 21. In the closed position of the lid 20 (see FIGS. 5a and 5b), the cover part 21 forms a homogenous optical as well as largely tight closure against the penetration of dust and the like with its side (cover surface 27a), which faces outwards.

As follows further from the perspective illustration in FIG. 4 (illustration of the water container 10 according to the embodiment in the attached state to the beverage machine 100) or from FIGS. 7a and 7b, respectively, the lid 20 can be pivoted into the unfolded position shown in FIG. 4 as well as 7a and 7b, namely by means of the rotatability about the joints 31a, 31b of the guide arms 30a or 30b, respectively, on the container side on the one hand as well as by means of the joints 32a, 32b of the guide arms 30a or 30b, respectively, on the lid side, on the other hand. In the illustrated unfolded position, a cover surface 27b of the lid 20, which is embodied on the contact part 22 of the lid, comes in contact with an outer wall of the water container 10 in such a manner that the longitudinal side 25a of the lid located on the bottom comes to rest significantly below the upper flange of the filling opening 11 of the water container 10. At the same time, the longitudinal side of the lid 25b, which is located on the top, is thus also shifted downwards considerably relative to the water container 10 in its installed position, so that the lateral area 51, which faces away from the machine, as well as the filling area 50 are exposed across a large area when refilling in the attached state of the water container 10 or are accessible, respectively.

For handling the water container 10 when it is removed from the beverage machine 100, it is possible at the same time to pivot the lid 20 by means of the guide device (guide arms 30a, 30b, joints 31a, 31b on the container side, joints 32a, 32b on the lid side) into such a position that the lid can also be used as carry handle. It hereby benefits the solution according to the invention, as is also reflected in the embodiment, that a comfortably manageable position of the lid for carrying can be assumed due to the rotatably movable support about the joints 31a, 31b on the container side on the one hand and furthermore about the joints 32a, 32b on the lid side, namely with a large contact surface for the hand of the person carrying it. As follows hereby from the illustrations in FIG. 5b or 6b, respectively, the center of gravity of the water container 10 is furthermore shifted out of the center of the carried water container 10 within an imaginary horizontal plane due to the eccentric arrangement of the joints 31a, 31b on the container side when using the lid 20 as carry handle for the water container 10, which makes carrying easier.

It is important to point out here that the instant invention is not limited to the described embodiment. Modifications and additions to the description above are well-known to the person of skill in the art and are also included in the inventive idea.

1. A water container for a beverage machine, which water container has a filling opening, which can be covered by means of a lid and which is embodied so as to be capable of being attached to the beverage machine and to be removed from the beverage machine, so that, when the water container is attached to the beverage machine, a filling area is defined above the filling opening,
wherein the lid is arranged on the water container so as to be movable and is guided by means of a guide device in such a manner that the lid can be pivoted out of the filling area into at least one predetermined or predeterminable open position, so that the filing area can be accessed freely at least from the top,
wherein the lid is supported in a rotatable manner by means of the guide device in such a manner that a cover surface of the lid can be brought into at least partial contact with an outer surface of the water container in the open position or in at least one of the open positions, respectively, so that the lid assumes an unfolded position.

2. The water container according to claim 1, wherein the lid has a substantially rectangular base area and is supported by means of the guide device on two sides of the lid, which are located opposite one another, so that the lid is pivotable about a first axis and rotatable about a second axis.

3. The water container according to claim 2, wherein, in the unfolded position of the lid, at least one side of the lid is located below a flange of the filling opening.

4. The water container according to claim 2, wherein the lid has a contact part, which, in a closed position of the lid, faces the inner side of the container of the water container, as well as a cover part, which, in the closed position of lid, is exposed to the outside.

5. The water container according to claim 4, wherein the cover surface is a surface of the contact part, which is located on the outside.

6. The water container according to claim 1, wherein the guide device for supporting and for guiding the lid has a first guide arm and a second guide arm located opposite thereto, wherein each of the guide arms has a joint on the container side for supporting the corresponding guide arm on the container in a rotatably movable manner and, in each case, a joint on the lid side for supporting the lid in a rotatably movable manner.

7. The water container according to claim 1, wherein, in the open or at least partially open state, respectively, the lid can be used as carry handle for the water container.

8. The water container according to claim 1, wherein the lid is supported eccentrically on the water container.

9. A beverage machine, preferably a fully automatic coffee machine, which is provided with a water container according to claim 1 for being provided with fresh water so as to prepare beverages.
